(19) United States
(12) Patent Application Publication
(10) Pub. No.: US 2010/0033734 A1
(43) Pub. Date: Feb. 11, 2010

(54) Vehicle frame deformation measurement apparatus and method

(76) Inventors: Darryl Koop, Marysville, WA (US); James Craig HartI, Snohomish, WA (US)

Correspondence Address: Eric R. Katz, 6115 Brook LN, Acworth, GA, 30102, US

(21) Appl. No.: 12/221,968

(22) Filed: Aug. 8, 2008

(51) Int. Cl. G01B 11/00

(52) U.S. Cl. 356/622

(57) ABSTRACT

An apparatus and method are provided for indicating deformation of a vehicle body when the vehicle body has reference points and a normal position thereof. The apparatus and method comprising the use of at least one target positioned at a predetermined location relative to the reference point on the vehicle body. The target is adapted to provide information indicating the position of the target relative to said normal position thereof when a laser scanner sweeps a laser beam across the target to activate the target and provide target location information. A computer is provided for receiving the target location information and calculating the position of the target relative to normal position. The laser source of the laser scanner is a Diode Pumped Solid State (DPSS) laser to provide stable beam output and prevent beam drift to prove a more accurate measurement.

### FIELD OF THE INVENTION

The general invention relates to vehicle frame deformation measurement apparatus and method for use in repairing bent or damaged vehicle frames by determining the location of targets attached to the frame at pre-determined reference points to calculate the extent of deformation of the vehicle frame; and more particularly, to a laser measurement system employing a special and more accurate lasing configuration to dramatically reduce beam steering and improve measurement.

### BACKGROUND

Vehicles frames currently have manufacturer-provided reference openings or holes located at established reference points on the vehicle frames. Manufacturers also provide specifications for the correct three-dimensional spatial locations of these reference points relative to each other. When a vehicle frame is damaged resulting in deformation of the frame, these reference points are displaced from their normal or “specification” positions with respect to each other. To correct this misalignment vehicle frame straightening jobs require return of the vehicle frame reference points to within manufacturer specifications.

Apparatus and methods for determining the deformation of a vehicle frame are disclosed, for example, by U.S. Pat. Nos. 4,997,283, 5,251,013 and 5,801,834 which use a pair of rotating laser light beams emitted from a laser measuring unit to scan passive reflective targets attached at the reference holes on the frame. The laser measuring unit used by these apparatus typical comprises a helium-neon laser that emits a laser beam which is split into two laser beams by a 50/50 beam splitter, each beam then being directed to a rotating mirror. The rotating mirrors direct the laser beams in a 360 degree circle, with both beams being directed in a single plane. The beams sweep across the surfaces of the reflective targets attached to the reference holes on the vehicle.

The targets have strips of reflective and non-reflective material to create a pulsed beam of reflected laser light. The retro-reflector reflects back the pulsed beam toward the scanning means where it is received in a photoreceptor to determine the angles of the target edges. The distance to the target and the width are inversely proportional to the length of time that the light beam scans across the target. The laser light also scans across a reference point and the length of time between this reference point and the reflection from the target is directly proportional to the azimuthal position of the target relative to the reference.

Therefore, in such systems, the pulses of reflected laser light from the targets are sensed and counted by the laser measuring unit as the beams sweep across the surfaces of the reflective targets which are attached to the reference holes on the frame. The resulting count is then used by a computer to calculate the position of the targets, compare it to a reference data base and then calculate the deformation of the vehicle frame.

In addition, U.S. Pat. No. 7,181,856 discloses the use of active targets in a laser measurement system to determine vehicle frame deformation for automobile collision repair. The active targets do not reflect laser light, but rather sense its position on the active target by electro-optical means and provide that information to a computer. The plurality of active targets are suspended from known reference points on the vehicle flame and their actual positions calculated by the computer and compared with manufacturer-provided specification values to determine the extent of deformation of the vehicle frame.

Typically, such laser measurement systems use diode lasers as the laser source which are relatively unstable and rarely can be specified to better than 1 or 2 nm. Typical deleterious operational characteristics of diode lasers include a modified output beam position and/or direction which can affect applications. Misalignment is caused by mechanical stress applied to the laser housing or by thermal effects resulting in the position of the beam wandering or moving. The latter can arise from temperature changes or from heating caused by parts of the laser itself resulting in the laser beam shifting its position and frequency.

This is an inherent property of laser diodes, that as it changes temperature, it changes frequency and when it shifts frequency or moves mechanically, the beam steers. For example, if you locked a laser into a clamp and pointed it at a wall 100 feet away and then changed the temperature of the laser the point on the wall would move. Some of the methods that have been used to stabilize this beam steering are to control the temperature of the laser or to force it to mode hop so that the average of the steering minimizes the measurement error.

In solid-state bulk lasers, the effect of misalignment is often strongly related to a shift of the beam position in the laser resonator. This beam position can be affected by the angular position of any optical element, in particular by tilting of mirrors. Further, an effective misalignment can also result from a change in the pump beam position because this can cause some asymmetry of the thermal lens. Such an asymmetry can cause the intra-cavity laser beam to be deflected, and might also affect the beam via gain guiding if the gain is high.

In optical systems, beam steering may be compensated for by changing the refractive index of the medium through which the beam is transmitted or by the use of mirrors or lenses or by using proprietary software to offset these variations during the calculation process. However, such approaches do not fully address the problem with the thermal effects on laser performance and measurement accuracy would greatly improved if beam steering was eliminated.

### SUMMARY OF THE INVENTION

Accordingly, it is an object of the invention to provide an arrangement for locating an object in three dimensional space using a laser measurement system employing a laser source constructed to dramatically reduces the beam steering and improve measurement.

It is another object of the present invention to provide vehicle frame deformation laser measurement system for use in repairing bent or damaged vehicle frames by determining the location of targets attached to the frame at pre-determined reference points to calculate the extent of deformation of the vehicle frame which employs a special and more accurate lasing configuration for dramatically reducing beam steering and improve measurement.

These and other advantages of the present inventor are achieved by use of a green Diode Pumped Solid State (DPSS) laser as the laser source instead of a diode laser. A green laser uses a laser diode or laser diode array shining into a relatively long crystal rod to excite the crystal rod and emit the green laser beam. This rod is much longer than the small laser diode element so the emitted laser beam is aimed more accurately. In addition, since the lasing of the beam is decoupled from the steering effect on the laser diode it has almost no drift or movement and is extremely stable.

### BRIEF DESCRIPTION OF THE DRAWINGS

FIG. 1 is a schematic illustration of one embodiment of a laser measurement system of for use in repairing a deformed vehicle frame in accordance the present invention; and

FIG. 2 is a perspective view of the laser scanner employing the Diode Pumped Solid State laser of the present invention.

### DETAILED DESCRIPTION OF THE PREFERRED EMBODIMENTS

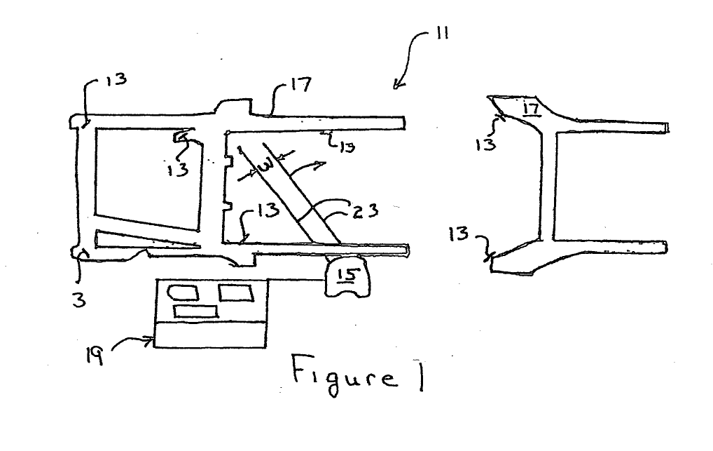

Referring to FIG. 1, one embodiment of a laser measurement system, generally indicated at 11, is shown in accordance with the teaching of the present invention for use, for example, in automotive collision repairs of a vehicle frame 17. The system 11 comprises three primary elements: a rotating laser transmitter/scanner 15 employing a Diode Pumped Solid State (DPSS) laser as its laser source, a plurality of targets 13 which can be reflective in accordance with the teachings of U.S. Pat. Nos. 4,997,283, 5,251,013 and 5,801,834 or electronic optical detector elements in accordance with the teachings of U.S. Pat. No. 7,181,856 the entire teachings of which are herein incorporated by reference The targets 13 are attached to frame 17 in at pre-determined reference points.

A host computer, generally shown at 19, can be equipped with software to compare position data received from the targets 13 with stored reference data delineating the optimal or “as-built” configuration of the frame 17 to display a simulated model of the frame of the vehicle showing the difference between as-built configuration and the actual configuration of the vehicle frame in three dimensions.

The rotating laser scanner 15 is positioned under the vehicle so that the scanning laser beams sweep a full 360 degrees underneath the frame 17 to be repaired. The axis of rotation r of scanner 15 and angular position of the scanner 15 relative to the frame are determined by the host computer 19 from the position data received from scanning the targets 13 and used as the reference point and angle from which the relative position of the targets 13 are determined.

The targets 13 are hung plumb under the influence of gravity from known locations or reference points on the frame to position each of the targets 13 below the frame 17 and within view of the scanner 15. The targets 13 are oriented so that they are facing the scanner 15 for reflection or detection of the pair of laser beams 23 as the laser beams 23 sweeps across the face of each of the targets 13.

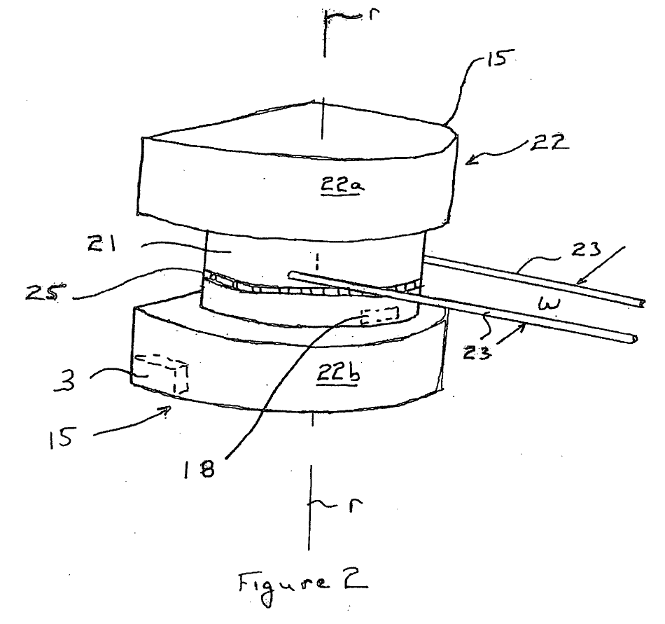

In operation, as the laser scanner 15 rotates the parallel laser beams 23 so as to sweep across the face of the target 13 to provide positional data to the he host computer 19. Referring to FIG. 2, the rotating laser transmitter/scanner 15 comprises, for example, a single rotating hub 21 from which two substantially parallel laser beams 23 are emitted perpendicular to the axis of rotation r which forms the reference point location of the scanner 15. This reference point r is determined by the host computer software from the position data received from the targets 13. The scanner 15 has a housing, generally indicated at 22, that comprises top and bottom portions 22a, 22b respectively shaped to permit the orientation of the scanner 15 either on its side or its base (as shown in FIG. 2) so that the scanning laser beam can be emitted in a substantially horizontal plane (as shown) or a substantially vertical plane, i.e., on the flat portion of the scanner seen on the left side of the drawing. With the laser scanner 15 in the vertical position the laser measurement system 11 can also measure the side of the vehicle and upper body points.

The rotating laser scanner 15 can have a tilt sensor 18 which indicates the deviation of the plane of rotation of the laser beams 23 from the horizontal. This feature is important because the measurement of the laser beams 23 at the targets 13 (which are all adapted to hang plumb under the influence of gravity) requires compensation for any tilt of the scanner 19 since this out of square condition effects the calculation of the radial distance of the targets 13 from the scanner reference point r. This also allows the out of level condition of the vehicle to be calculated and compensated for.

The parallel scanning laser beams 23 are generated by a pair of parallel lasers units or a single laser unit using a Diode Pumped Solid State (DPSS) laser as its laser source. The laser units are mounted on a rotating platform and the Diode Pumped Solid State (DPSS) lasers use a high power laser diode pump source to excite a crystal rod used as the lasing medium. The wavelength of the pump diodes is selected to match an absorption line in the lasing medium. (For Nd:YAG and Nd:YVO₄, this is around 800 nm.). Therefore, this pumping technique can be much more efficient than using a broadband source like a xenon flashlamp.

In accordance with the teachings of the present invention, the DPSS laser preferably comprises a green Diode Pumped Solid State (DPSS) laser where a high power IR laser diode or array of laser diodes provides the excitation to optically pumped a crystal based laser instead of a flashlamp or other intense light source. The green DPSS laser produces a laser beam having a wavelength at about 554 nm (green). Output power ranges from a few mW for green DPSS laser pointers to more than a kilowatt for industrial DPSS lasers.

A green DPSS laser is typically designed for SHG Second Harmonic, 532 nm green for a YAG lasing medium. DPSS wavelengths are accurate and stable to better than 0.1 nm whereas diode laser wavelengths can rarely be specified better than 1 or 2 nm.

The rotating hub 21 includes, for example, periscope-style correction of laser pitch and yaw when the pair of beams 23 are generated from a single laser unit, and split with a beam dividing prism into the two parallel beams. By splitting one beam into two halves, instead of using two laser beam generators, discrepancy in the error from one of the parallel beams 23 as compared to the other of the parallel beams 23 is easily eliminated; because only the one source beam has error, each of the beams 23 carries the same error, which is accounted for in software. The rotation of the laser beams 23 defines a 360-degree, roughly planer surface, which can be either vertical or horizontal depending on the orientation of the rotating hub 21 transmitted from the scanner 15.

Although the present invention has been described in terms of specific exemplary embodiments, it will be appreciated that various modifications and alterations might be made by those skilled in the art without departing from the spirit and scope of the invention as specified in the following claims.

What is claimed is:

1. Apparatus for indicating deformation of a vehicle body, said vehicle body having at least one reference point and a normal position thereof, said apparatus comprising:
at least one target positioned at a predetermined location relative to the reference point on the vehicle body for providing information indicating the position of the target relative to said normal position thereof;
a laser scanner for sweeping a laser beam across the target to activate said target and provide target location information, said laser scanner having a laser source; and
a computer for receiving the target location information and calculating the position of the target relative to normal position;
wherein the laser source comprises a Diode Pumped Solid State (DPSS) laser.

2. An apparatus according to claim 1, wherein the DPSS laser has a stable wavelength within about 0.1 nm of the stable wavelength.

3. An apparatus according to claim 1, wherein the DPSS laser is a green DPSS laser.

4. An apparatus according to claim 1, wherein the DPSS laser is designed for SHG (Second Harmonic, 532 nm green) for a YAG lasing medium

5. An apparatus according to claim 1 wherein the target is a passive retro-reflecting target.

6. An apparatus according to claim 5, wherein the passive retro-reflecting target has a pattern of reflective and non-reflective surfaces which are scanned by the laser beam to generate target position data.

7. An apparatus according to claim 1 wherein the target is an active target are active which generates target position data when the laser beam sweeps across the target.

8. A method for indicating deformation of a vehicle body, said vehicle body having at least one reference point and a normal position thereof, said method comprising the steps of:
positioned at least one target, at a predetermined location relative to the reference point on the vehicle body, for providing target location information indicating the position of the target relative to said normal position thereof;
sweeping a laser beam, from laser source, across the target to activate said target and provide target location information; and
using a computer for receiving the target location information and calculating the position of the target relative to normal position;
wherein the laser source comprises a Diode Pumped Solid State (DPSS) laser.

9. A method according to claim 8, wherein the DPSS laser has a stable wavelength within about 0.1 nm of the stable wavelength.

10. A method according to claim 8, wherein the DPSS laser is a green DPSS laser.

11. A method according to claim 8, wherein the DPSS laser is designed for SHG (Second Harmonic, 532 nm green) for a YAG lasing medium

12. A method according to claim 8, wherein the target is a passive retro-reflecting target.

13. A method according to claim 12, wherein the passive retro-reflecting target has a pattern of reflective and non-reflective surfaces which are scanned by the laser beam to generate target position data.

14. A method according to claim 8, wherein the target is an active target are active which generates target position data when the laser beam sweeps across the target.

15. Apparatus for measuring accidental deformation of a vehicle comprising:
a laser source and measuring unit, adapted for placement under the vehicle;
a plurality of coded reflective targets adapted to be positioned with respect to predetermined locations on the vehicle;
computer including reference data of the normal location, with respect to a reference plane, of said predetermined locations on the vehicle; and
a processing program for accepting output from the source and measuring unit representing the deformed position of said points as computed based on reflections from the coded targets and for processing the output and comparing it to the reference data whereby the amount of deformation may be indicated,
wherein the laser source and measuring unit includes a DPSS laser source for generating two laser beams, and a rotating hub on which the DPSS laser source is mounted and rotates, whereby each laser beams sweeps an entire 360.degree. arc.

16. An apparatus according to claim 15, wherein each coded reflective target comprises at least two reflective areas separated by a non-reflective area, wherein the width of each of the two reflective areas at which the beam sweeps across the surface of the coded target is indicative of a Z coordinate of the target, and the total width of the target is indicative of X,Y coordinates of the target.

17. An apparatus according to claim 16, wherein each coded target is rectangular in overall shape having vertical sides defining its width and top and bottom sides defining its height, the reflective areas are positioned to each of the vertical sides respectively, and extend substantially between the top and bottom sides of the target while varying inversely in width over their length between the top and bottom of the target.

18. An apparatus according to claim 17, wherein each coded target further including an additional reflective area and an additional non-reflective area, said additional areas extending substantially between the top and bottom sides of the target means, each of said areas being of a predetermined width so that the combination of the additional reflective and non-reflective areas provide a code for uniquely identifying each coded reflective target.

19. An apparatus according to claim 15, wherein the DPSS laser has a stable wavelength within about 0.1 nm of the stable wavelength.

20. An apparatus according to claim 15, wherein the DPSS laser is a green DPSS laser.
